(19) United States
(12) Patent Application Publication
(10) Pub. No.: US 2004/0238187 A1
(43) Pub. Date: Dec. 2, 2004

(54) Weed cutter with rolling support for angling a cutting edge

(76) Inventor: Jonathan Paul Ruppert, Sacramento, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/899,954

(22) Filed: Jul. 26, 2004

(51) Int. Cl. A01B 5/00; A01B 49/02

(52) U.S. Cl. 172/13

(57) ABSTRACT

A weed cutting apparatus removes top growth of undesirable plants penetrating cracks, crevices and surface interfaces relative to a ground surface. The apparatus has an elongate linear handle for pulling it along while standing or walking. A pair of spaced apart wheels are mounted at one end of the handle and fixedly mounted between the wheels is a cutting tool. The cutting tool is oriented relative to the handle such that with the wheels in contact with the ground surface, the cutting tool is positionable at a selected cutting angle relative to the ground surface with a cutting edge of the cutting tool thus positioned above, below or in the plane of the ground surface depending on the angle at which one holds the handle relative to the ground surface.

### BACKGROUND OF THE INVENTION

1. Related Applications

None

2. Incorporation by Reference

Applicant(s) hereby incorporate herein by reference, any and all U.S. patents and U.S. patent applications cited or referred to in this application.

3. Field of the Invention

This invention relates generally to sidewalk and curb crevice weed cutters and more particularly to a weed cutter mounted on wheels and having a handle that places a weed cutting blade in a position to cut above, below or at a sidewalk surface level depending on the angle at which the handle is held.

4. Description of Related Art

Albertson, U.S. Pat. No. 4,611,666, teaches a crack and crevice weeder device for cleaning undesirable growth from cracks or crevices in expansion joints between sidewalks and streets. A V-shaped cutting head is attached to an end of a U-shaped rod and a triangular shaped scraper can be attached to a point on the U-shaped rod. The U-shaped rod is fixed to a long handle which enables an operator, while standing, to remove undesirable growth from cracks or crevices and expansion joints by pulling the weeder towards him, while simultaneously applying a downward pressure.

Wolf-Garten GmbH & Co KG of Betzdorf/Sieg, Germany, otherwise known as WOLF Garden, teaches in their, “The New Product Finder” catalog, on page 4 at the upper left corner, a garden weeder/planter comprising a hand tool with an L-shaped metal blade.

Albertson represents the closest prior art to the present invention. However, the prior art fails to teach a rolling cutter of the Albertson type where the cutting blade can be maintained at a selected height above, at or below ground level while the tools is supported at ground level by wheels, for establishing a uniform cutting plane. The present invention fulfills these needs and provides further related advantages as described in the following summary.

### SUMMARY OF THE INVENTION

The present invention teaches certain benefits in construction and use which give rise to the objectives described below.

In a best mode preferred embodiment of the present invention, a weed cutting apparatus removes top growth of undesirable plants penetrating cracks, crevices and surface interfaces relative to a ground surface. The apparatus has an elongate linear handle for pulling it along while standing or walking. A pair of spaced apart wheels are mounted at one end of the handle and fixedly mounted between the wheels is a cutting tool. The cutting tool is oriented relative to the handle such that with the wheels in contact with the ground surface, the cutting tool is positionable at a selected cutting angle relative to the ground surface with a cutting edge of the cutting tool thus positioned above, below or in the plane of the ground surface depending on the angle at which one holds the handle relative to the ground surface.

A primary objective of one embodiment of the present invention is to provide an apparatus and method of use of such apparatus that yields advantages not taught by the prior art.

Another objective is to assure that an embodiment of the invention is capable of being easily drawn by hand for cleaning cracks and crevices of floral growth.

A further objective is to assure that an embodiment of the invention is capable of being manually angled for setting a cutting element at a desired level relative to the ground surface.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective view of a lower portion of the invention;

FIG. 2 is a further perspective view thereof showing how the invention is used to cut weeds in a crack or crevice;

FIG. 3 is a perspective view of the crack or crevice shown after the invention has cut such weeds;

FIG. 4 is a side elevational view of the invention illustrating the method for holding a handle of the invention at an angle Beta relative to the ground surface so as to position a cutting edge of the invention adjacent to, or on a surface in the crack or crevice in the ground surface; and

FIG. 5 is a perspective view showing the invention in use.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

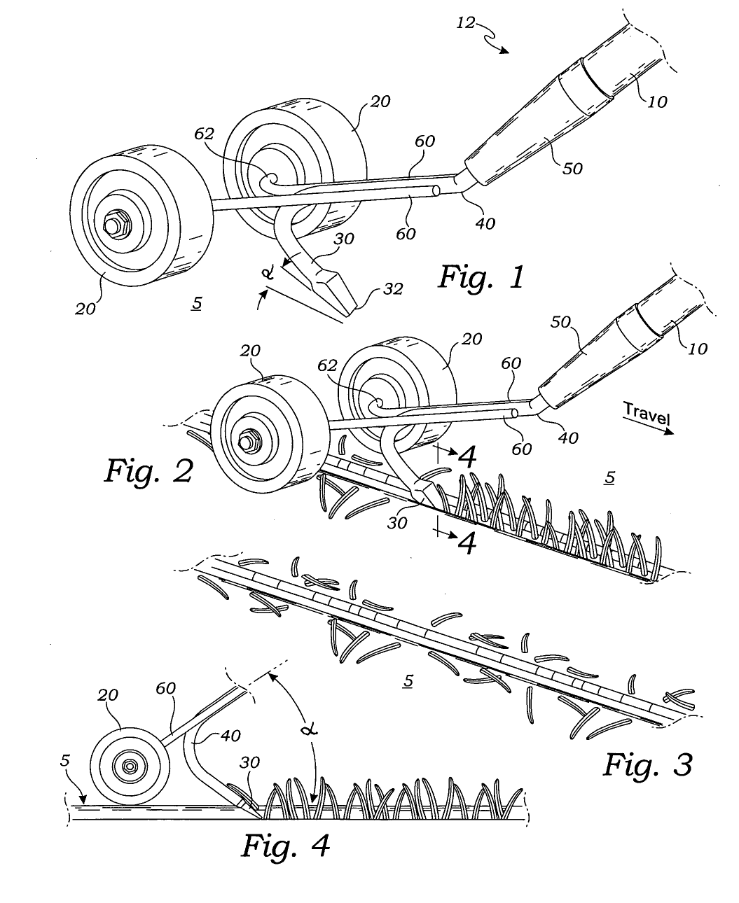

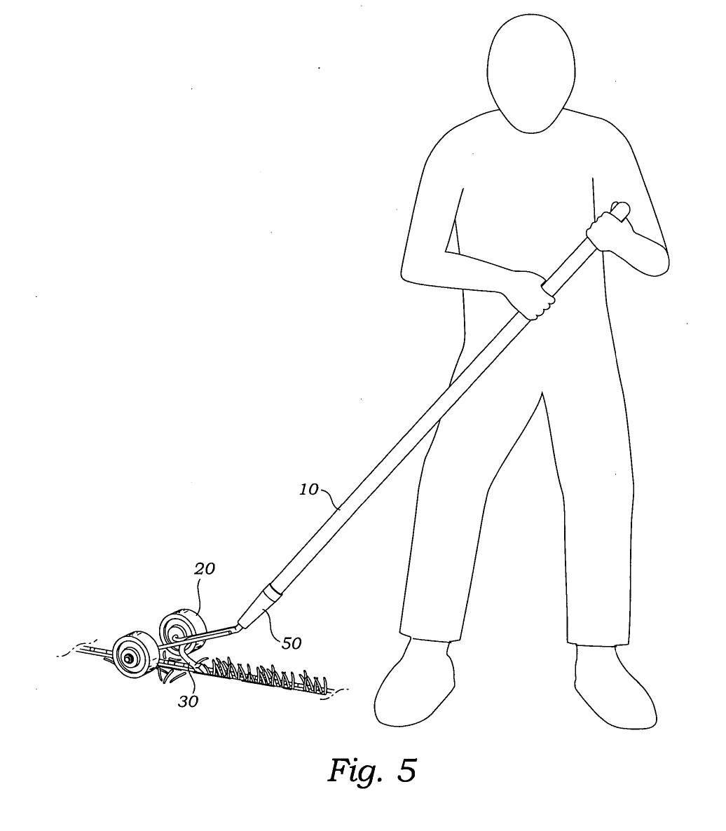

In one aspect of a best mode embodiment of the present invention a weed cutting apparatus is adapted, as will be described below, for removing top growth of undesirable plants which are known for penetrating cracks, crevices and surface interfaces relative to a ground surface 5 which defines a localized plane. The apparatus comprises an elongate linear handle 10, such as used for brooms, mops, light rakes, and such, for pulling the apparatus along while standing or walking. A pair of spaced apart wheels 20, such as rubber or plastic roller-skate type wheels, are mounted at one end 12 of the handle 10. Fixedly mounted between the wheels, is a metal or similar material cutting tool 30 capable of holding a keen edge, as is shown in FIG. 1. Here, the cutting tool 30 is shown as having a chisel edge, but edges of other forms may alternately be used depending on the size and type of a crack or crevice that the tool is used for. The cutting tool 30 is fixedly oriented relative to the handle 10 such that with the wheels 20 in contact with the plane of the ground surface 5, the cutting tool 30 is positionable at a selected cutting angle (shown as Greek letter Alpha in FIG. 1) relative to the ground surface 5 with a cutting edge 32 of the cutting tool 30 thereby positioned above, below or in the plane of the ground surface 5 depending on a manually positionable angle (shown as Greek letter Beta in FIG. 4) formed between the handle 10 and the plane of the ground surface 5. The cutting edge 32 is positioned forward of the wheels 20 when the apparatus is moving in a direction for cutting (shown by a large arrow in FIG. 2). This enables the cutting edge 32 to be moved vertically over a range of angles Alpha for small variations in angles Beta. The cutting tool 30 is preferably formed as a terminal element or part of a stem 40 configured by its size and shape for insertion into a tool holder 50, where the tool holder 50 is mechanically engaged with both the handle 10 and the stem 40 and forms a transition piece between these two parts. The wheels 20 are preferably mounted on L-shaped rods 60, where the L-shaped rods 60 are attached to opposing sides of the stem 40 by welding or any other known fastening method. The L-shaped rods 60 are oriented so that distal terminal portions 62 of these rods 60 are collinear. The terminal portions 62 are oriented in the horizontal and are adapted by their size and shape for receiving the wheels 20 in rotational engagement.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A weed cutting apparatus for removing top growth of undesirable plants penetrating cracks, crevices and surface interfaces relative to a ground surface; the apparatus comprising: an elongate linear handle for pulling the apparatus along while standing or walking; a pair of spaced apart wheels mounted at one end of the handle; fixedly mounted between the wheels, a cutting tool, the cutting tool fixedly oriented relative to the handle such that with the wheels in contact with the ground surface, the cutting tool is positionable at a selected cutting angle relative to the ground surface with a cutting edge of the cutting tool thereby positioned above, below or in the plane of the ground surface depending on a manually positionable angle formed between the handle and the plane of the ground surface.

2. The apparatus of claim 1 wherein the cutting edge is positioned forward of the wheels when the apparatus is moved in a direction for cutting.

3. The apparatus of claim 1 wherein the cutting tool is formed as a terminal element of a stem configured for insertion into a tool holder where the tool holder is engaged with both the handle and the stem.

4. The apparatus of claim 3 wherein the wheels are mounted on L-shaped rods, the L-shaped rods attached to opposing sides of the stem.

5. The apparatus of claim 4 wherein the L-shaped rods are oriented so that distal terminal portions thereof are collinear, the terminal portions receiving the wheels in rotational engagement.

6. A weed cutting apparatus for removing top growth of undesirable plants penetrating cracks, crevices and surface interfaces relative to a ground surface; the apparatus comprising: an elongate handle; at least one wheel mounted at one end of the handle; a cutting tool oriented relative to the handle such that with the at least one wheel in contact with the ground surface, the cutting tool is positionable at a selected cutting angle relative to the ground surface with a cutting edge of the cutting tool thereby positioned above, below or in the plane of the ground surface depending as manually adjustable with the handle.

7. The apparatus of claim 6 wherein the cutting edge is positioned forward of the wheels when the apparatus is moved in a direction for cutting.

8. The apparatus of claim 6 wherein the cutting tool is formed as a terminal element of a stem configured for insertion into a tool holder where the tool holder is engaged with both the handle and the stem.
